(19) United States
(12) Patent Application Publication
(10) Pub. No.: US 2026/0308391 A1
(43) Pub. Date: Oct. 8, 2026

(54) PANELS, METHOD FOR MANUFACTURING PANELS, MIXTURE AND LACQUER

(71) Applicant: UNILIN, BV, Wielsbeke (BE)

(72) Inventors: Martin SEGAERT, Wielsbeke (BE); Milan THOEN, Wielsbeke (BE)

(21) Appl. No.: 19/480,690

(22) PCT Filed: May 8, 2024
(86) PCT No.: PCT/IB2024/054481

§ 371 Date: Oct. 31, 2025

Related U.S. Application Data
(60) Provisional application No. 63/501,403, filed on May 11, 2023.
(60) Provisional application No. 63/581,987, filed on Sep. 12, 2023.
(60) Provisional application No. 63/587,176, filed on Oct. 2, 2023.
(60) Provisional application No. 63/613,081, filed on Dec. 21, 2023.

(51) Int. Cl. C09D 5/16; C09D 7/45; C09D 7/63; C09D 175/04; E04F 15/02

(52) U.S. Cl. CPC C09D 5/1662; C09D 7/45; C09D 7/63; C09D 175/04; E04F 15/02038; E04F 2201/0153; E04F 2201/023; E04F 2201/042; E04F 2201/043

(57) ABSTRACT

A method for manufacturing panels, and such panels, wherein the panels include a substrate and a top layer. The panels are provided with a first pair of opposite edges with coupling parts. The first pair of opposite edges include a first edge and a second edge, and the method includes the step of forming the coupling parts, and subsequently at least the following two steps: applying a lacquer on the first edge; applying a mixture including hydrophobic components on at least a part of the first edge, and preferably also the second edge; such that the first edge has both the lacquer and the hydrophobic components. The lacquer and/or the mixture includes a wetting agent.

The present invention relates to panels, such as floor panels and a method for manufacturing panels. This invention also relates to a lacquer and also to a mixture that can be used when manufacturing panels.

In particular the invention relates to panels that are used for assembling for example a floating floor covering. Floor panels of this kind are known for example from WO97/47834 and may be provided on two opposite edges with profiled edge regions that comprise milled coupling means that fit into one another, with which two floor panels of this kind can be coupled together on the respective edges, preferably without using glue. Optionally the coupling means may be configured with some pretension, which means that the contour of the coupling means is configured as somewhat overlapping, so that in the coupled state a stress arises that pushes the panels together. This pretension is advantageous for counteracting the formation of gaps after laying. The penetration of dust and moisture may also be limited thereby. In some cases the milling quality of the coupling means is insufficient to keep the seams permanently waterproof. Moreover, at the location of the corner points of such panels there is increased susceptibility to water penetration. The profiled edge regions of adjacent lateral edges cross at the location of the corners, and therefore it is possible that the milled coupling means may be absent or insufficient there.

The penetration of moisture into the seams of a floor covering that is assembled from panels may, in the case of panels with a moisture-sensitive substrate and/or top layer, such as a substrate based on MDF or HDF (medium or high density fibreboard), lead to swelling and/or discoloration, which may be annoyingly visible on the decorative surface of such panels. In addition, such swelling of the substrate may in itself lead to accelerated wear of the floor surface. Furthermore, the penetration of moisture in the seams of a floor covering is problematic per se, even if neither the substrate nor the top layer is moisture sensitive. In such cases water may collect under the floor covering and this may give rise to mould formation and the unpleasant effects of that.

It is known from WO2008/078181 to treat the edges of a floor panel with an MDF or HDF substrate with a water-repellent substance that comprises a fluorinated polymer or copolymer. The substance in question is applied on the edge of the floor panel by means of a so-called vacumate, for example of the type as known from DE9202976U1.

The present invention aims firstly to offer alternative methods for manufacturing panels, wherein according to various preferred embodiments, a solution can be offered for one or more of the problems with the methods and/or panels from the prior art. In particular, one aim of the invention is to describe methods that allow optimal water resistance of panels to be obtained more easily.

The invention is described in the independent claims. Embodiments are described in the dependent claims.

The first aspect of the invention relates to a method for manufacturing panels,
wherein the panels are rectangular, either square or oblong, and comprise a substrate and a top layer;
wherein the panels are provided with at least a first pair of opposite edges with coupling parts, which allow two such panels to be coupled to each other, wherein in a coupled position a locking is created in a direction perpendicular to the plane of the coupled panels and/or in a direction in the plane of the panels and perpendicular to the coupled side edges, wherein the first pair of opposite edges comprise a first edge and a second edge, and wherein the method comprises the step of forming the coupling parts, and subsequently at least the following two steps:
   applying a lacquer on at least a part of the first edge, and preferably also on at least a part of the second edge;
   applying a mixture comprising hydrophobic components on at least a part of the first edge, and preferably also on at least a part of the second edge, the mixture being different from the lacquer;
such that at least a portion of the first edge, and preferably also a portion of the second edge, comprises both the lacquer and the hydrophobic components,
wherein the lacquer and/or the mixture comprises a wetting agent, wherein preferably said lacquer and/or mixture comprises between 0.1 and 5 percent by weight of said wetting agent.

The presence of a wetting agent, either in the lacquer or either in the mixture or in both the lacquer and the mixture, ensures that the hydrophobic components and/or the lacquer get well spread over at least the part of the edge upon which the mixture and/or the lacquer is applied. Said hydrophobic components provide the edges with water repellent properties. By making use of a said wetting agent, it is ensured that the desired water repellent properties are always obtained and there is little fluctuation in the quality of the manufactured panels trough-out the process. The wetting agent also has a moistening effect, so that a better adhesion is obtained.

The percent by weight is preferably expressed based on the total weight of the mixture and/or the lacquer. This because said mixture and/or said lacquer could comprise water, for example could be water based, or could comprise a solvent.

In a specific embodiment of the method, applying said lacquer is performed before applying said mixture. In another specific embodiment of the method, applying said mixture is performed before applying said lacquer. Applying said mixture and/or applying said lacquer can be done in two or more partial steps. If two or more of said partial steps are present, it is possible that applying said lacquer and/or applying said mixture is at least partially performed before applying respectively said mixture and/or lacquer and is also at least partially performed after applying respectively said mixture and/or lacquer.

In a first alternative to the method according to the first aspect, only a lacquer is applied on at least a part of the first edge, and preferably also on at least a part of the second edge, wherein said lacquer comprises said hydrophobic components. In this first alternative, no separate mixture is applied, and the lacquer preferably comprises said wetting agent. The below mentioned embodiments of the lacquer and/or the below mentioned embodiments of the hydrophobic components are also possible embodiments for this alternative. Further, below mentioned components of said mixture can also be components of the lacquer of this alternative. The invention also relates to a said lacquer as such, said lacquer optionally comprising said wetting agent.

In a second alternative to the method according to the first aspect, only a mixture is applied on at least a part of the first edge, and preferably also on at least a part of the second edge, wherein said mixture preferably comprises pigments and/or colourants. In this second alternative, no separate lacquer is applied, and the mixture preferably comprises said wetting agent. The below mentioned embodiments of the mixture are also possible embodiments for this second alternative. Further, below mentioned components of said lacquer can also be components of the mixture of this second alternative. The invention also relates to a said mixture as such, said mixture optionally comprising said wetting agent.

Said wetting agents can be alcohols, such as long-chain alcohols or 3,5-dimethyl-1-hexyn-3-ol. Preferably said wetting agents migrate and/or evaporate away, such that the panels, when they are installed, no longer comprise said wetting agents.

Preferably the lacquer is water based and the lacquer preferably comprises a said wetting agent, for example comprises 3,5-dimethyl-1-hexyn-3-ol. Further preferably said lacquer comprises at least 0.5 weight percentage of said wetting agent, more preferably at least 1 weight percentage of said wetting agent, most preferably at least 2 weight percentage of said wetting agent and/or at most 4 weight percentage of said wetting agent. For example said lacquer comprises between 2,8 and 3,2 weight percentage of said wetting agent, for example between 2,9 and 3,1 weight percentage of said wetting agent, said wetting agent preferably being 3,5-dimethyl-1-hexyn-3-ol. By having said wetting agent in said quantities, good adhesion of said lacquer to the substrate is obtained at the height of the said edge. If said lacquer is applied after the mixture, then, as an alternative to the lacquer comprising said wetting agent, the mixture can comprise said wetting agent, and this preferably in the same percentages by weight as described for the lacquer above.

If the mixture is also water based, the said mixture preferably comprises a said wetting agent, for example comprises 3,5-dimethyl-1-hexyn-3-ol. Further preferably said mixture comprises at least 0.5 weight percentage of said wetting agent, more preferably at least 1 weight percentage of said wetting agent, most preferably at least 2 weight percentage of said wetting agent and/or at most 4 weight percentage of said wetting agent. For example said mixture comprises between 1,3 and 1,7 weight percentage of said wetting agent or comprises between 2,8 and 3,2 weight percentage of said wetting agent, for example between 2,9 and 3,1 weight percentage of said wetting agent, said wetting agent preferably being 3,5-dimethyl-1-hexyn-3-ol. By having said wetting agent in said quantities, good adhesion of said hydrophobic components to the panel is obtained at the height of the said edge. If said mixture is applied after the lacquer, then, as an alternative to the mixture comprising said wetting agent, the lacquer can comprise said wetting agent, and this preferably in the same percentages by weight as described for the mixture above. If said mixture is solvent based, the said mixture could not comprise said wetting agent. However if the mixture is solvent based, it could also comprise said wetting agent in the same percentages by weight as described above.

Most preferably, both said lacquer and said mixture comprise said wetting agent, and this further preferably in the quantities described above, being at least 0.5 weight percentage, more preferably at least 1 weight percentage, most preferably at least 2 weight percentage and/or at most 4 weight percentage, and for example between 2,8 and 3,2 weight percentage or between 2,9 and 3,1 weight percentage.

The hydrophobic components comprise or are preferably hydrophobic polymers such as hydrophobic polycarbodiimides, hydrophobic polyurethanes or hydrophobic acrylate polymers or hydrophobic polysilazanes, wherein the hydrophobic polymers preferably comprise an aliphatic hydrocarbon group, for example with 6 to 34 carbon atoms. The aliphatic hydrocarbon group can be selected from the group containing: linear hydrocarbon chains, branched hydrocarbon chains and alicyclic hydrocarbon chains. Preferably, a hydrocarbon group indicates a group with exclusively hydrogen (H) and carbon (C). However, halogenated hydrocarbon groups, with for example one, two or more fluorine atoms, are also possible. Also one or more hydrogens (H) may be replaced by a hydrophobic compound, e.g. a hydrophobic compound is bounded to said hydrocarbon group. Preferably the hydrophobic components do not comprise fluorine atoms and more preferably the mixture does not comprise fluorine atoms.

The hydrophobic components can be amphiphilic copolymers comprising at least the following recuring units:

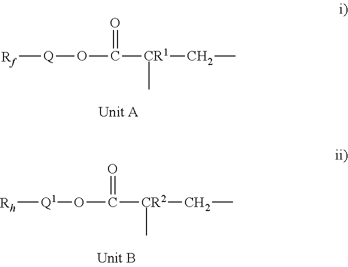

wherein R_{f} and R^{h} are alkyl groups with between 2 and 22 carbon atoms, preferably at least 3 carbon atoms and more preferably at least 16 carbon atoms, for example between 16 and 22 carbon atoms, wherein said alkyl groups can be aliphatic alkyl groups, branched alkyl groups or cycloaliphatic alkyl groups, such as cyclohexane;
wherein R¹ and R² are alkyl groups with between 1 and 4 carbon atoms, for example aliphatic alkyl groups, or wherein R¹ an R² are hydrogen atoms;
wherein Q and Q′ are linking groups or a bond. Said linking groups can be an aliphatic or an aromatic linking group. A said linking group is preferably being chosen from the list of: straight chain, branched chain, cyclic alkylene, arylene, oxy, oxo, hydroxy, thio, sulfonyl, sulfoxy, amino, imino, sulfonamido, carboxyamide, carbonyloxy, urethanylene, urelyne, and combinations thereof. For example the linking group can sulfonamidoalkylene or other groups such as

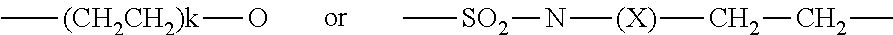

wherein k is 1 or 2 and X is an alkyl group with between 1 and 4 carbon atoms.

A said amphiphilic copolymer can be produced by free radical polymerization of the monomers A and B, and for example an ethylenically unsaturated monomer having a carboxylic acid group or a salt of a carboxylic acid group or a precursor of a carboxylic acid group. Said ethylenically unsaturated monomer can have the following formula:

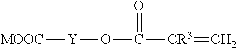

with M being a hydrogen atom or a cation such as a sodium ion, a potassium ion or an ammonia ion. R³ is a hydrogen atom or an alkyl group with 1 to 4 carbons. Y are linking groups or a bond, such as Q and Q′. If the abovementioned hydrophobic component is present, the mixture is preferably catatonically stabilized. If the abovementioned hydrophobic component is present, the mixture is preferably water-based mixture.

In a very preferred embodiment, the hydrophobic components comprise A-B-A block copolymers or other copolymers comprising A and B, wherein A is preferably an acrylate, e.g. a hydrophobic acrylate comprising for example a said aliphatic hydrocarbon group with 6 to 34 carbon atoms, and wherein B is a urethane, said urethane comprising or not comprising a carbodiimide group. Said urethane can be an octadecylurethane. If the abovementioned hydrophobic component is present, the mixture is preferably solvent-based mixture.

The hydrophobic components can be or comprise silanes and/or (poly)siloxanes and/or polysilazanes and/or cyclic siloxanes and/or (modified) alkyd resins and/or (modified) acryl resins and/or benzoate esters and/or silica and/or metallic soaps. For example the hydrophobic components can comprise propoxy silanes and/or ethoxy silanes and/or methoxy silanes. Ethoxy silanes and/or methoxy silanes can comprise hydroxylgroups which can bound with the hydroxylgroups of a wood based substrate. For example the hydrophobic components can comprise decamethylcyclopentasiloxane and/or 3-aminopropyltriethoxysilane and/or hexamethyldisilazane and/or organic polysilazanes and/or octadecyltriethoxysilane and/or hexadecyltriethoxysilane. The hydrophobic components can comprise N-ethyl-3-trimethoxysilyl-2-methylpropanamine. The hydrophobic components can comprise polyurethane modified alkyd, acrylated alkyd, silicone-modified alkyd and/or thixotropic alkyd. Benzoate esters have been found to provide edges with very good water repelling properties.

The hydrophobic polymers can be provided in the form of: a cationic acrylate copolymer dispersion, an anionic alkyd polyurethane emulsions and/or an anionic acrylic polyurethane emulsions.

The mixture preferably comprises, besides said hydrophobic components, a solvent-different from water- or water. Further said mixture can comprise an alkyd resin. This alkyd resin can or cannot be seen as a hydrophobic component. For example, only one or more of the most hydrophobic components can be indicated as the hydrophobic components. If an alkyd is used, this is preferably a polyurethane-modified alkyd and/or an alkyd of the “long oil alkyd” type. “Long oil alkyd” types have the advantage that they dry quickly. Instead of an alkyd resin or in addition to said alkyd resin, the mixture can comprise a polyurethane resin. Said polyurethane resin can be modified with tall oil fatty acids. Instead of an alkyd resin or in addition to said alkyd resin, the mixture can comprise an oil, such as a modified linseed oil.

The mixture can for example comprise an organic solvent, an alkyd resin, a urethane polymer, a titanate, additives and optionally a wetting agent. The urethane polymer is preferably a hydrophobic polymer, and more preferably a hydrophobic polymer comprising a said aliphatic hydrocarbon group with 6 to 34 carbon atoms. The urethane polymer is preferably a polyurethane. The composition can be (percentages by weight): 34% organic solvent, 25% alkyd resin, 30% urethane polymer, 3% titanate, 5% additives, 3% wetting agent. The composition can also be (percentages by weight): 30% urethane polymer, 37% organic solvent, 5% 2-ethylhexylacetate (e.g. a cosolvent additive), 25% long-oil alkyd resin, 3% 2-ethylhexyltitanate. The additives can be chosen from the list of: antifreeze agents, coagulating agents, cosolvents, emulsifiers or stabilizers, metallic soaps, drying agents, catalysts and biocides against one or more microorganisms. The additives can comprise metallic soaps. Said metallic soaps preferably comprise an aliphatic chain comprising at least 8 carbons, more preferably at least 12 carbons and most preferably at least 16 carbons. More preferably said metallic soaps also comprise one, two or more shorter aliphatic chains, e.g. aliphatic chains with at most 6 carbons, preferably at most 4 carbons. Said metallic soaps can be obtained from animal fats or plant/vegetable fats. A said mixture can comprise up to 7 percentage of weight of metallic soaps, for example up to 5 percentage of weight, preferably between 1 and 5 percentage by weight, for example between 2 and 4 percentage by weight. The metallic soaps are preferably zinc metallic soaps or calcium metallic soaps or magnesium metallic soaps. An example of possible metallic soaps is zinc stearate. Metallic soaps can contribute to the soap resistance of respective edges of the panel. The organic solvent can be or comprise hydrocarbons with between 11 and 14 carbons (hydrocarbons C11-C14). Titanates, such as 2-ethylhexyltitanate, enhances the soap resistance of the mixture.

The mixture can for example comprise water, a polyurethane modified alkyd emulsion, an organic polysilazane, additives and a wetting agent. The composition can be (percentages by weight): 42% water, 25% alkyd resin, 40% polyurethane modified alkyd emulsion, 5% organic polysilazane, 10% additives, 3% wetting agent. The additives can be chosen from the list of: antifreeze agents, coagulating agents, cosolvents, emulsifiers or stabilizers, drying agents, catalysts, metallic soaps (for example as described in the above paragraph), and biocides against one or more microorganisms.

The mixture can for example comprise water, a cationic acrylate copolymer dispersion, a wetting agent, a coalescent, a metal-based catalyst and a hydrophobic fumed amorphous silica. The water gives the desired viscosity, the cationic acrylate copolymer dispersion and the hydrophobic fumed amorphous silica provide water resistance, the wetting agent (which is for example 3,5-dimethyl-1-hexyn-3-ol), improves wetting such that the mixture can be applied very homogeneously, and the metal-based catalyst shortens drying time. The mixture for example comprises between 50 and 55 wt % of water, between 37 and 43 wt % of cationic acrylate copolymer dispersion, between 1 and 2 wt % of wetting agent, between 0.5 and 1.5 wt % of metal-based catalyst and between 0.25 and 0.75 wt % of hydrophobic fumed amorphous silica.

The mixture can for example comprise water, a cationic acrylate copolymer dispersion, a wetting agent, a metal-based catalyst and a silane (such as octadecyltriethoxysilane). The water gives the desired viscosity, the cationic acrylate copolymer dispersion and the silane provide water resistance, the wetting agent (which is for example 3,5-dimethyl-1-hexyn-3-ol), improves wetting such that the mixture can be applied very homogeneously, and the metal-based catalyst shortens drying time. The mixture for example comprises between 50 and 55 wt % of water, between 42 and 48 wt % of cationic acrylate copolymer dispersion, between 1 and 2 wt % of wetting agent, between 0.5 and 1.5 wt % of metal-based catalyst and between 0.25 and 0.75 wt % of silane.

The mixture can for example comprise water, an anionic alkyd polyurethane emulsion, an anionic acrylic polyurethane emulsion, an anionic paraffin/wax emulsion, a wetting agent, a metal-based catalyst and a hydrophobic fumed amorphous silica. The water gives the desired viscosity, the anionic alkyd polyurethane emulsion provides water resistance, the wetting agent (which is for example 3,5-dimethyl-1-hexyn-3-ol), improves wetting such that the mixture can be applied very homogeneously, and the metal-based catalyst shortens drying time. The anionic acrylic polyurethane emulsion, the anionic paraffin/wax emulsion and the hydrophobic fumed amorphous silica further improve the water resistance. The mixture for example comprises between 45 and 53 wt % of water, between 37 and 43 wt % of anionic alkyd polyurethane emulsion, between 3 and 5 wt % of an anionic acrylic polyurethane emulsion, between 3 and 7 wt % of anionic paraffin/wax emulsion (e.g. a carnauba wax emulsion), between 1 and 2 wt % of wetting agent, between 0.5 and 1.5 wt % of metal-based catalyst and between 0.25 and 0.75 wt % of hydrophobic fumed amorphous silica.

The mixture can comprise hydrophobic components, an organic solvent, a cosolvent, and additives chosen from the list of titanates and silicon containing components such as silanes and silica. For example the mixture can have the following composition (percentages by weight): 50% hydrophobic polyurethane, 37% organic solvent, 5% cosolvent (e.g. 2-ethylhexylacetate), 3% 2-ethylhexyltitanate, 0.5% octadecyltriethoxysilane. The mixture can also have the following composition (percentages by weight): 50% hydrophobic polyurethane, 21% organic solvent, 21% cosolvent (e.g. 2-ethylhexylacetate) and 1,5% fumed amorphous silica. The organic solvent can be or comprise hydrocarbons with between 11 and 14 carbons (hydrocarbons C11-C14). Titanates, such as 2-ethylhexyltitanate, enhances the soap resistance of the mixture. The organic solvent can be or comprise hydrocarbons with between 15 and 20 carbons (hydrocarbons C15-C20). The latter is useful in hotter areas. Silanes, such as octadecyltriethoxysilane, enhances the soap resistance of the mixture. Fumed amorphous silica enhances the water-repellent properties of the mixture. Mixtures with at least 50% hydrophobic polyurethane are very useful for substrates which are very prone to swelling.

The application of said lacquer can be done in one single step, or can be done in two partial steps or three or more partial steps. The application of said mixture can be done in one single step, or can be done in two partial steps or three or more partial steps. For example the mixture/lacquer can be applied upon a said edge and this with the aid of one application device or two application devices or three or more application devices. These application devices can be or cannot be the same, and can be chosen from the non-exhaustive list of: spraying devices, such as spray heads, needle guns, plasma torches, or transfer disks/rollers and vacuum application devices such as vacumates. The choice of the number of application devices and/or the type of application devices depends on the desired thickness, the speed of the panels-since normally the panels are transported alongside an application device-. After each said step or after a said partial step of applying a said lacquer or mixture, drying and/or curing can be present, this drying and/or curing can be a complete drying and/or curing or can be a partial drying and/or curing. If partial drying and/or curing is used, drying and/or curing preferably takes place until the mixture or lacquer is touch dry. From the above it is clear that, between two of said partial steps, a drying and/or curing can take place. The curing can be heat curing, e.g. curing with infrared lights, and/or can be UV-curing, e.g. curing with UV lights.

Preferably, the application of said lacquer and/or the application of said mixture, is done while the panel is transported on a transporting device. Said transporting device can or cannot be incorporated in a milling machine, which milling machine profiles said side edge. The transporting device is preferably a chain transporting device. For the application of said lacquer and/or the application of said mixture, use can be made of one or more application devices which are lined up alongside the transporting device. The application devices can be chosen from the list of: spray heads, needles, vacuum techniques—e.g. vacumates-, transfer wheels, transfer rollers, etc. If needles are used, said needles can have a circular opening or another shape of opening. For example the opening can have an oval shape or a more rectangular shape, as such to be able to apply enough lacquer and/or mixture upon said first edge. For example the needle can have a tip that is pressed as such to obtain a flattened tip and/or compressed tip. The largest dimension of a cross section of an opening of the tip, e.g. the diameter if the opening is circular shaped, can be between 0.1 and 1.6 mm.

Preferably at least part of the mixture penetrates into the substrate of said respective edge to a certain depth, for example penetrates at least 1 mm or between 0.1 mm and 0.5 mm. For this, preferably at least a part of the hydrophobic components have particles size which are smaller than 60 nanometer. This particle size can be measured with the aid of laser diffraction and/or disk centrifuge. More preferably at least part of the hydrophobic components is present at the surface and most preferably the hydrophobic components at least have parts that are directed away from the panel, for example are directed outwards. If the hydrophobic components comprise said aliphatic hydrocarbon groups with for example 6 to 34 carbon atoms, these aliphatic hydrocarbon groups are preferably directed outwards, such that they are very well suited to provide the panels with water repellent properties. More preferably at least part of the hydrophobic components has penetrated the side edge, e.g. are present between the wood fibers or wood chips if the panels comprise a wood fiberboard or particle board substrate, such to provide the side edge with good water-repellent properties. It has been found that the best water-repellent properties are obtained when at least part of the hydrophobic components is present at the surface of the lacquer (if a lacquer is present) and at least part of the hydrophobic components have penetrated the side edge. If no lacquer is present and only the mixture is applied, then the best water-repellent properties are obtained when at least part of the hydrophobic components is present at the surface of the side edge and at least part of the hydrophobic components have penetrated the side edge.

In a preferred embodiment the lacquer comprises a said wetting agent and also the mixture comprises a said wetting agent, wherein the wetting agent of the lacquer and the wetting agent of the mixture may or may not be the same. Preferably the wetting agent of the lacquer is the same as the wetting agent of the mixture and more preferably the wetting agent is 3,5-dimethyl-1-hexyn-3-ol. This ensures that the hydrophobic components and also the lacquer are homogenously distributed during application, and good adhesion is obtained. Of course, the wetting agent of the lacquer and the wetting agent of the mixture can be different, but compatible. Since both the wetting agent and the lacquer comprise a wetting agent, adhesion with the substrate is very good, and adhesion between the lacquer and the hydrophobic components of the mixture is also very good. The hydrophobic components of the mixture are preferably present at the height of the lacquer, preferably adhered to the upper surface of the lacquer, and are well suited to perform their water repellent properties, such that the water repellent and hydrophobic properties of the panel are enhanced, and also said hydrophobic components are homogenously distributed and variations during the method are reduced.

In a very preferred embodiment, the first edge, and preferably also the second edge, comprises a lowered edge which extends from the top layer into the substrate, for example in the form of a chamfer or bevel, wherein the lacquer and the mixture are at least applied upon said lowered edge and wherein the lacquer forms a decoration separate from the top layer. Preferably the top layer is a decorative top layer, for example a top layer comprising a wood decor or a stone decor. With the aid of said lacquer the lowered edge preferably obtains a colour, which for example matches said decorative top layer, such that the decoration of said lowered edge differs from said decorative top layer. The lacquer can comprise a dye, a paint or pigments, to provide the lowered edge with the desired look and colour. This lacquer can provide an aesthetic lowered edge, for example in the form of a chamfer, while this lowered edge has superior water repellent properties by said hydrophobic components. Even if said substrate is a water absorbent substrate, such as an MDF or HDF or particle board, by applying said lacquer and mixture upon said lowered edge at the height of the substrate, said substrate obtains sufficient water repellent properties.

Further preferably, the entire contour of the lowered edge is treated with said lacquer, and preferably also with said mixture. This means that the application of said lacquer, and also preferably the application of said mixture, is done upon substantially the entire contour of the lowered edge, thus also upon the substrate. Further preferably said mixture is also applied directly below said lowered edge, such to enhance the water repellent properties.

Further preferably said lowered edge can be formed by means of a mechanical cutting operation with the aid of a knife or a milling device. Preferably the formation of said lowered edge and the application of said lacquer and the application of said mixture are done in the same continuous process.

The lacquer is preferably water based. The lacquer can be an acrylate dispersion or a polyurethane dispersion, or the lacquer can comprise an alkyd resin.

The lacquer preferably comprises additives, for example additives for providing and/or enhancing water repellent properties. These additives can comprise wax, for example an anionic paraffin/carnauba wax emulsion and/or hydrophobically modified synthetic wax. These additives can also comprise other emulsions such as anionic emulsions based on acrylic polymers. Preferably said wax does not or hardly penetrate the substrate, but is present at the height of the surface of the applied lacquer, such that the wax can optimally perform its water-repellent properties.

The mixture is preferably solvent based, more preferably wherein the mixture comprises a solvent with a flashpoint of at least 60° C., preferably at least 80° C., more preferably at least 100° C., most preferably at least 120° C. and/or wherein more preferably the mixture is VOC free or comprises at most 1 percent by weight of VOC's. VOC's are volatile organic compounds. With a solvent is indicated a solvent different from water. The solvent can comprise one or more of: a glycol ether, propylene glycol methyl ether, propylene glycol methyl ether acetate, hydrocarbons—preferably aliphatic hydrocarbons and/or preferably iso-hydrocarbons-, butyl acetate, propyl acetate—for example 3-methoxy-3-methyl-1-butyl acetate (MMB-AC) or 1-methoxy-propyl acetate (MPA)-, 2-ethylhexylacetate, a dibasic ester, a glycol diether, a benzoate ester, a phthalate ester or a tetramethoxy ether. Solvents being or comprising benzoate esters have been found to provide mixtures with good water repelling properties. The solvent-based mixture can comprise for example alkanes, such as iso-alkanes or branched alkanes or aliphatic hydrocarbons. The alkanes preferably have 10 to 20 carbon atoms, for example between 11 and 14 carbon atoms or between 15 and 20 carbon atoms. In order to increase the flash point, use may be made of 3-methoxy-3-methyl-1-butanol acetate. Thus, the mixture may for example comprise between 8 and 12 wt % of 3-methoxy-3-methyl-1-butanol acetate. If the mixture is solvent based, the dry matter content of the mixture is preferably between 5 and 20 percentage by weight, or example between 10 and 15 percentage by weight.

The aforementioned solvent-based mixture comprises for example one or more of the following components: ethylhexyl acetate, propyl acetate or butyl acetate—for example 3-Methoxy-3-Methyl-1-ButylAcetate (MMB-AC) or 1-MethoxyPropyl Acetate (MPA)-, triethyl citrate, propylene glycol methyl ether, propylene glycol methyl ether acetate, 2-ethylhexylacetate, dibasic ester, glycol diether, benzoate ester, phthalate ester, dipropylene glycol dimethyl ether or a tetramethoxy ether. These components may or may not be indicated as cosolvents. The weight percentage of solvents described in the above paragraph, can be approximately the same as the weight percentage of the cosolvents mentioned in this paragraph. For example the mixture can comprise between 20 and 25 wt % of solvents, e.g. solvents comprising alkanes, and between 20 and 25 wt % of cosolvents, e.g. 2-ethylhexyl acetate. Benzoate esters have been found to be very good cosolvents.

The solvent-based mixture may optionally comprise additional additives. The solvent and the additives may for example be exclusively of the aliphatic type, or the proportion of solvent and additive of the aromatic type in the mixture is less than 1000 ppm, or less than 100 ppm.

The use of such solvents is preferred because good stability of the liquid is obtained, necessary for the processability thereof; and because good impregnation of the edge(s) of the panel with the mixture is obtained.

Preferably, after the appliance of the mixture, no active drying takes place. This is particularly useful when the mixture is solvent based.

Preferably, after the appliance of the lacquer, an active drying takes place. This is particularly useful when the lacquer is water based.

The mixture could also be water based. If the mixture is water based, the dry matter content is preferably lower than 10 percentage by weight.

The mixture could be water based and could comprise a cationic acrylate copolymer dispersion to provide the mixture with water resistance. For example the mixture could comprises between 40 and 60 wt % of water and between 30 and 50 wt % of said cationic acrylate copolymer dispersion. Said mixture could further comprise additional components to further enhance the water resistance such as silanes (for example octadecyltriethoxysilane) and/or hydrophobic fumed amorphous silica and/or a metallic soap. Said mixture could further comprise a wetting agent and/or a metal-based catalyst to shorten the drying time and/or a coalescent.

The mixture could be water based and could comprise an anionic alkyd polyurethane emulsion to provide the mixture with water resistance. For example the mixture could comprise between 40 and 60 wt % of water and between 30 and 50 wt % of said anionic alkyd polyurethane emulsion. Said mixture could further comprise additional components to further enhance the water resistance such as silanes (for example octadecyltriethoxysilane) and/or hydrophobic fumed amorphous silica and/or an anionic acrylic polyurethane emulsion and/or an anionic paraffin/wax emulsion. Said mixture could further comprise a wetting agent and/or a metal-based catalyst to shorten the drying time and/or a coalescent.

In a very preferred embodiment applying the lacquer takes place before applying the mixture, and wherein preferably
the method comprises a step of drying, wherein the lacquer is at least partially dried, wherein said step of drying takes place after applying said lacquer and before applying the mixture; and/or
   the method comprises the step of curing, wherein the lacquer is at least partially cured, wherein said step of curing takes place after applying said lacquer and before applying the mixture;
and wherein more preferably, the step of drying and the step of curing are one and the same step. Here, firstly the lacquer is applied and then the mixture, wherein between the application of the lacquer and the application of the mixture, the lacquer is at least partially dried/cured. Since the step of drying and/or the step of curing is done before the application of the mixture, the mixture can be solvent based without any risks. Preferably, when the mixture is applied, the lacquer is at least partially in a wet state, thus not fully dried/cured, such that the hydrophobic components are well distributed and the mixture adheres well to the lacquer. For example the lacquer could be touch dry when applying the mixture.

Further preferably, said lacquer comprises a said wetting agent, and said wetting agent is still present when applying said mixture. This way the wetting agent of the lacquer ensures good adhesion and good spreading of said hydrophobic components. Even more further preferably said wetting agent migrates and/or evaporates away from the panel after application of said mixture, such that the installed panel no longer comprises said wetting agent.

Said lacquer can be applied in excess to ensure that a sufficient amount of lacquer adheres to the said edge. If this is the case, then preferably, after the application of said lacquer, the method comprises a step of removing excess lacquer, for example by blowing and/or suction.

Further preferably the step of drying is done with the aid of one or more of the following list:
one or more infrared lamps, for example halogen infrared lamps;
a stream of gas, for example a hot air stream.

Further preferably the mixture penetrates at least partially trough the lacquer into the substrate of the said edge and at least a part of the hydrophobic components extend on the upper surface of the lacquer. This way, a good connection between the lacquer and the mixture is obtained, the hydrophobic components are well suited to perform their water repellent properties, and water is prevented from entering the substrate. Here part of the mixture is located below the lacquer, e.g. the mixture has at least partially penetrated the side edge, and part of the mixture is located above the lacquer.

Applying the lacquer and applying the mixture preferably takes place in one and the same continuous process.

The lacquer and/or the mixture can be applied by one of following:
application by spraying, by for example a spray head, a needle gun or a plasma torch;
application by a transfer wheel or transfer roll;
application under vacuum.

If spraying is used, one can spray with a pressure above 3 bar, above 5 bar or above 8 bar or one can spray at a pressure of at most 2 bar or at most 1 bar, for example a pressure between 0.1 and 0,9 bar, or a pressure between 0.2 and 0,8 bar, such as a pressure of 0.5 bar or a pressure of 0,6 bar. For example, use can made of a spray gun which sprays at a pressure of between 7 and 20 bar, for example 7 to 8 bar or 10 to 15 bar. For example use can be made of needles which spray at a pressure of between 0,3 and 1,5 bar or more. The opening of a said needle can have a diameter of between 0.1 and 1.54 mm.

In a very preferred embodiment, the lacquer comprises pigments and/or colorants. This is very well suited for the embodiment with the lowered edge, as such to obtain a so-called painted bevel or lacquered bevel. With the aid of this method an aesthetic edge can be obtained, and this while the edge is also water repellent. With the aid of pigments and/or colorants, one can provided the edge with the desired color and one can also match the color of the edge to the color or decor of the top layer, when the top layer is a decorative top layer. These pigments can be anionic pigments. These pigments can also be cationic pigments.

In a specific embodiment, the mixture comprises pigments and/or colorants. This is very well suited for the embodiment with the lowered edge, as such to obtain a so-called painted bevel. This is also very well suited to avoid white lines at the height of the decor. With the aid of this method an aesthetic edge can be obtained, and this while the edge is also water repellent. With the aid of pigments and/or colorants, one can provide the edge with the desired color and one can also match the color of the edge to the color or decor of the top layer, when the top layer is a decorative top layer. The pigments and/or colorants preferably are black or dark brown. These pigments can be anionic pigments. These pigments can also be cationic pigments.

In a specific embodiment, the mixture comprises crosslinkers. These crosslinkers can be aziridine crosslinkers or isocyanate crosslinkers. These crosslinkers can be present in an amount of between 0.5 and 2 percentage by weight. These crosslinkers enhance the resistance against soap and can also enhance the water resistance.

Preferably the first edge comprises a sealing face substantially perpendicular to the upper surface of the panel, and the second edge comprises a sealing face substantially perpendicular to the upper surface of the panel. The first edge of the panel may be coupled to the second edge of another such panel, wherein in the coupled state the sealing face of the first edge of the panel is in contact with or is close to the sealing face of the second edge of the other such panel. Preferably during applying of the mixture, said mixture is applied on a said sealing face. Through the contact of or the proximity of the sealing faces and because hydrophobic components are also present at said sealing faces, even better water resistance of a covering with such panels is obtained. If said first and/or second edge comprises also said lowered edge, then said sealing face is preferably directly located beneath said lowered edge. Further preferably at least said lacquer is applied upon said lowered edge and said mixture is applied upon both said lowered edge and said sealing face. Alternatively or additionally said mixture is applied upon the first edge or upon the second edge and this at the height of the part of the first edge or second edge that is located closest to or closely to the bottom of the panel, the bottom of the panel being the surface of the panel that is located at the bottom during use of the panel.

Preferably the coupling parts on the first pair of opposite edges are configured as overlapping, so that during coupling on the first pair of opposite edges, coupling with pretension is obtained.

Preferably, applying of said lacquer on at least a part of the first edge and/or applying of said mixture is carried out after and in line with the cutting operations—preferably milling operations—for making the coupling parts on the first edge of the panel.

Preferably the top layer comprises a decorative layer and a wear layer, for example wherein the decorative layer comprises a resin impregnated printed paper or a printed polymer film and wherein the wear layer comprises a resin impregnated transparent/translucent paper or a polymer film.

In a specific embodiment the panel also comprises a balancing layer, wherein the balancing layer and the top layer are located on opposite sides of the substrate. The balancing layer can be a resin impregnated paper.

Further preferably the panels are provided with a second pair of opposite edges, wherein also said mixture and said lacquer are applied on said second pair of opposites edges, and this in the same way as for the first pair of opposite edges. In this way, a very efficient method is obtained for making the edges of the panels water-repellent.

Preferably the lacquer and the mixture form a film with a thickness less than 50 micrometres, preferably less than 25 micrometres. This is especially important for ensuring good coupling of the panels.

The mixture can penetrate the substrate to a certain depth, preferably more than 1 millimetre into the respective edge.

In the specific embodiment the first edge is provided with a lowered edge and a sealing face substantially perpendicular to the surface of the panel; wherein the second edge is provided with a lowered edge and a sealing face substantially perpendicular to the surface of the panel; wherein in the coupled state of the panel with its first edge coupled to the second edge of another such panel, the sealing face of the first edge of the panel is in contact with or is close to the sealing face of the second edge of the other such panel. The method then preferably comprises the step of applying the mixture on the first edge and on the second edge, wherein the mixture penetrates at least partially into the sealing face of the first edge and into the sealing face of the second edge; and preferably penetrates on the lowered edges of the first edge and of the second edge. The lowered edges may for example be provided in the form of chamfers.

Preferably the sealing face of the first edge is directly adjacent to the lowered edge of the first edge, and the sealing face of the second edge is directly adjacent to the lowered edge of the second edge.

The substrate is preferably selected from or the substrate comprises:
a wood fibre board, for example an MDF (Medium Density Fibreboard) or HDF (High Density Fibreboard) board. Such a panel can be indicated as a laminate;
a chipboard, or
a mineral board, for example a magnesium oxide board, a plasterboard, a board made of mineral fibres bonded with a binder (for example by means of a thermosetting binder), or a fibre-cement board, or
a polymer-based substrate, for example such as a filled or unfilled and/or foamed polyvinyl chloride-based substrate or a substrate based on some other thermoplastic or thermosetting polymer. Such a panel can be an SPC (solid plastic composite) panel or an LVT (luxury vinyl tile) panel.

If the substrate is an MDF or HDF, it preferably has a swelling rate between 2 and 20%, as measured according to EN 317:1993. Even for low quality MDF or HDF, being MDF or HDF having a swelling of at least 10% or at least 15% as measured according to EN 317:1993, good water repellent properties can be obtained by applying said lacquer and said mixture to the at least part of a said edge. The swelling is measured by submerging the substrate in water having for example a pH of 7 and a temperature of 20° C. The characteristics of a said mixture can be adapted to the swelling of said MDF or HDF substrate. For example if the wood based substrates are low swell boards HDF, for example have a swelling of less than 10%, preferably less than 5%, more preferably less than 2%, measured according to EN 317:1993, the viscosity of a said mixture is preferably between 10 and 20 mPa·s, more preferably between 15 and 18 mPa·s, for example between 16 and 17 mPa·s, measured according to ISO 3219:1193. For example if the wood based substrates have a swelling of more than 10%, or more than 15% measured according to EN 317:1993, the viscosity of a said mixture is preferably between 25 and 50 mPa·s, preferably between 26 and 35 mPa·s, more preferably between 28 and 32 mPa·s, for example between 29 and 31 mPa·s measured according to ISO 3219:1193.

The viscosity of the mixture is determined by the components of the said mixture. For example the mixtures can have solvents comprising aliphatic hydrocarbons. For a higher viscosity, said hydrocarbons can have between 11 and 15 carbons, and for a lower viscosity said hydrocarbons can have between 15 and 20 carbons. To increase the viscosity of the mixture, minerals oils and/or resins—e.g. alkyd resins—can be present or can be present in a higher amount.

The top layer can be a decorative top layer comprising a print, preferably wherein the decorative top layer is fastened directly or indirectly on an underlying substrate. The top layer may also comprise a wood veneer (thickness less than 2.5 mm) or a layer of wood (thickness starting from 2.5 mm), wherein a wood veneer preferably has a thickness between 0.4 and 0.8 mm.

The invention also relates to a method for manufacturing panels, whether or not according to (a said alternative of) the first aspect of the invention,
wherein the panels are rectangular, either square or oblong, and comprise a substrate and a top layer, wherein the top layer comprises a wood veneer or a layer of wood,
wherein the panels are provided with at least a first pair of opposite edges with coupling parts, which allow two such panels to be coupled to each other, wherein in a coupled position a locking is created in a direction perpendicular to the plane of the coupled panels and/or in a direction in the plane of the panels and perpendicular to the coupled side edges, wherein the first pair of opposite edges comprise a first edge and a second edge, and wherein the method comprises the step of forming the coupling parts, and subsequently one or more of the following two steps:
applying a lacquer on at least a part of the first edge, and preferably also on at least a part of the second edge;
   applying a mixture comprising hydrophobic components on at least a part of the first edge, and preferably also on at least a part of the second edge, the mixture being different from the lacquer—if present;
such that at least a portion of the first edge, and preferably also a portion of the second edge, comprises the lacquer and/or the hydrophobic components,
wherein the lacquer and/or the mixture preferably comprises a wetting agent, wherein more preferably said lacquer and/or mixture comprises between 0.1 and 5 percent by weight of said wetting agent. More preferably said first pair of opposite edges have end grain. Wood grain indicates the longitudinal arrangement of wood fibers. End grain is at right angles to the wood grain and is the most susceptible to water, since the wood fibers are cut through at right angles. For elongate rectangular panels with a pair of long edges and a pair of short edges, these first opposites edges with end grain, are often the short edges. It is possible that a said lacquer and/or a said mixture comprising hydrophobic components are not applied to the second edges, and thus only applied to the first edges. This because, when the first edges comprise end grain, said second edges are less sensitive to water. However preferably, also a said lacquer and/or a said mixture comprising hydrophobic components are applied to the second edges, but for example in a lesser amount. For example the amount of lacquer and/or mixture applied upon said first edges can be at least twice the amount of lacquer and/or mixture applied upon said second edges, preferably at least three times the amount. When a said lacquer and/or a said mixture are applied to both the first edges and the second edges—and this for example in the same amount or in a lesser amount for the second edges-, the composition of a said lacquer and/or a said mixture can be different for the first edges and the second edges. For example the viscosity of a said lacquer and/or mixture applied to the first edges can be higher than the viscosity of a said lacquer and/or mixture applied to the second edges. With the latter, too deep penetration at the height of the end grain can be avoided. For example the hydrophobic components can be different and/or the amount of resin can be different. For the second edges, the viscosity of a said mixture is preferably between 10 and 20 mPa·s, more preferably between 15 and 18 mPa·s, for example between 16 and 17 mPa·s, measured according to ISO 3219:1193. For the first edges with end grain, the viscosity of a said mixture is preferably between 25 and 35 mPa·s, more preferably between 28 and 32 mPa·s, for example between 29 and 31 mPa·s measured according to ISO 3219:1193.

The invention also relates to a method for manufacturing panels, whether or not according to (a said alternative of) the first aspect of the invention,
wherein the panels are rectangular, either square or oblong, and comprise a substrate and a top layer, wherein the substrate is a wood based substrate, for example an MDF, HDF or particle board,
wherein the panels are provided with at least a first pair of opposite edges with coupling parts, which allow two such panels to be coupled to each other, wherein in a coupled position a locking is created in a direction perpendicular to the plane of the coupled panels and/or in a direction in the plane of the panels and perpendicular to the coupled side edges, wherein the first pair of opposite edges comprise a first edge and a second edge, and wherein the method comprises the step of forming the coupling parts, and subsequently one or more of the following two steps:
applying a lacquer on at least a part of the first edge, and preferably also on at least a part of the second edge;
   applying a mixture comprising hydrophobic components on at least a part of the first edge, and preferably also on at least a part of the second edge, the mixture being different from the lacquer—if present-;
such that at least a portion of the first edge, and preferably also a portion of the second edge, comprises the lacquer and/or the hydrophobic components,
wherein the lacquer and/or the mixture preferably comprises a wetting agent, wherein more preferably said lacquer and/or mixture comprises between 0.1 and 5 percent by weight of said wetting agent. Preferably the characteristics, for example the viscosity, of the mixture and/or lacquer is adapted to the swelling characteristics of the wood based substrate.

The invention also relates to a method for manufacturing panels, whether or not according to (a said alternative of) the first aspect of the invention,
wherein the panels are rectangular, either square or oblong, and comprise a substrate and a top layer, wherein the substrate comprises a polymer, for example such as a polyvinyl chloride or some other thermoplastic or thermosetting polymer. Such a substrate can be indicated as a polymer-based substrate, for example a thermoplastic-based substrate such as a PVC-based substrate. This substrate can or cannot comprise fillers, for example organic fillers such as wood or inorganic fillers such as chalk, limestone or CaCO₃. The substrate can or cannot be foamed. The substrate can or cannot comprise plasticizers. The panels are then for example so-called SPC panels (stone plastic composite) or LVT panels (luxury vinyl tile). The panels are provided with at least a first pair of opposite edges with coupling parts, which allow two such panels to be coupled to each other, wherein in a coupled position a locking is created in a direction perpendicular to the plane of the coupled panels and/or in a direction in the plane of the panels and perpendicular to the coupled side edges, wherein the first pair of opposite edges comprise a first edge and a second edge, and wherein the method comprises the step of forming the coupling parts, and subsequently one or more of the following two steps:
applying a lacquer on at least a part of the first edge, and preferably also on at least a part of the second edge;
   applying a mixture comprising hydrophobic components on at least a part of the first edge, and preferably also on at least a part of the second edge, the mixture being different from the lacquer—if present;
such that at least a portion of the first edge, and preferably also a portion of the second edge, comprises the lacquer and/or the hydrophobic components,
wherein the lacquer and/or the mixture preferably comprises a wetting agent, wherein more preferably said lacquer and/or mixture comprises between 0.1 and 5 percent by weight of said wetting agent. Preferably the characteristics, for example the viscosity, of the mixture and/or lacquer is adapted to the swelling characteristics of substrate. Polymer-based substrates as indicated above do not swell or hardly swell under the influence of water, such that a said mixture preferably has a low viscosity, for example a viscosity of between 10 and 20 mPa·s, more preferably between 15 and 18 mPa·s, for example between 16 and 17 mPa·s, measured according to ISO 3219:1193. For example said mixture cannot comprise a resin, such as an alkyd resin, or can comprise a said resin in amount of less than 5 weight percentages. The advantage of having a low viscosity mixture, is that drying of said mixture, after applying of said mixture, takes place is a fast manner.

The coupling parts of the first pair of opposite edges could be produced substantially in the form of a tongue and a groove, which in the coupled state provide locking in the direction perpendicular to the plane of the coupled panels, wherein the tongue and the groove are provided with locking elements, which in the coupled state of two such panels on their first pair of opposite edges provide locking in the direction in the plane of the panels and perpendicular to the coupled edges, wherein the groove is delimited by an upper lip and a lower lip, preferably wherein the lower lip projects farther in the distal direction than the upper lip, wherein the lower lip comprises a locking element in the form of an upwards directed locking element for interacting with a locking element on the underside of the tongue for forming locking in the direction in the plane of the panels and perpendicular to the coupled edges. The panel is then preferably coupled on its first edge to the second edge of another such panel by means of a turning motion and/or by pushing the panels together with a snap effect substantially parallel to the plane of the panels. If pretension is present, said lower lip is preferably arranged to deflect so as to be bent-out and push on said tongue to urge the coupled panels towards each other. For example the aforementioned lower lip in a coupled state could display a maximum deflection of at least 0.07 millimeter.

In a specific embodiment, the panel comprises a second pair of opposite edges with coupling parts. Said coupling parts can be of the same type as mentioned in the paragraph above, but can also be of the type that allow the panel to be coupled to another such panel by means of a downward motion of the panel relative to the other such panel; wherein the coupling parts of the second pair of opposite edges, in the coupled state of two such panels, form a first locking system on their second pair of opposite edges that provides locking in the plane of the coupled panels and perpendicular to the coupled edges; and form a second locking system in the direction perpendicular to the coupled panels; wherein the first locking system is formed at least by an upwards directed bottommost hook-shaped portion that is located on one of the aforementioned second pair of opposite edges, as well as a downwards directed upper hook-shaped portion that is located on the other, opposite edge of the aforementioned second pair of opposite edges, and these hook-shaped portions can be hooked in behind each other by means of the aforementioned downward motion; wherein the lower hook-shaped portion consists of a lip with an upwards directed locking element, whereas the upper hook-shaped portion consists of a lip with a downwards directed locking element; wherein the second locking system possesses locking elements in the form of locking surfaces. The second locking system may comprise an insert, for providing partial or complete locking in the direction perpendicular to the plane of the coupled panels. The second locking system may be made entirely of material of the substrate.

According to each of the various embodiments, several- and preferably all-edges of the panels may be treated or may have been treated in a comparable or identical manner. Thus upon each edge, preferably a said lacquer is applied and a said mixture is applied.

According to a deviating variant, the panels are not rectangular, but have another polygon shape, such as a hexagon shape or an octagon shape, wherein edges of said panel are treated in the same manner as described in the first aspect of the invention, namely that said lacquer is applied upon said edges and that said mixture is applied upon said edges. Therefore the method of the first aspect of the invention applies mutatis mutandis for all polygon shaped panels. According to another deviating variant, the panels are not rectangular, but have another polygon shape, such as a hexagon shape or an octagon shape, wherein edges of said panel are treated in the same manner as described in the first or second alternative to the method according to the first aspect, namely that said lacquer is applied upon said edges and/or that said mixture is applied upon said edges.

According to another deviating variant, a said wetting agent is optional. The first aspect of the invention as described above comprises many features which show benefits with regard to the state of the art, even when a said wetting agent is not present.

The invention, according to a second aspect, relates to a set of panels for a covering, for example a set of floor panels for a floor covering, wherein the panels are rectangular, either square or oblong, wherein the panels comprise a substrate and a top layer,
wherein the panels comprises at least a first pair of opposite edges with coupling parts, which allow two such panels to be coupled to each other, wherein in a coupled position a locking is created in a direction perpendicular to the plane of the coupled panels and/or in a direction in the plane of the panels and perpendicular to the coupled side edges, wherein the first pair of opposite edges comprise a first edge and a second edge, and wherein said first edge, and preferably also said second edge, is at least partially covered with a lacquer, wherein hydrophobic components extend on the upper surface of said lacquer.

Preferably, also hydrophobic components have penetrated into the substrate of a said respective edge to a certain depth, for example have penetrated at least 0.5 mm or at least 1 mm or between 0.1 mm and 0.5 mm. For this, preferably at least a part of the hydrophobic components have a particle size which is smaller than 60 nanometer. This particle size can be measured with the aid of laser diffraction and/or disk centrifuge. Preferably the substrate is a wood fiberboard substrate or a particle board substrate, such that the hydrophobic components are present between the wood fibers or wood chips

This set of panels can be manufactured by the method of the invention described above, e.g. the first aspect of the invention. All the benefits and embodiments described for this method, apply mutatis mutandis for this set of floor panels. Preferably this set of panels do not comprise said wetting agent, this because preferably the wetting agent migrates and/or evaporates away after the application of said lacquer and mixture.

Preferably the lacquer comprises pigments and/or colourants.

In a preferred embodiment the first edge comprises a sealing face, preferably substantially perpendicular to the plane of the coupled panels, and the second edge comprises a sealing face, preferably substantially perpendicular to the plane of the coupled panels, wherein in a coupled position, the sealing face of the first edge of the panel is close to the sealing face of the second edge of the other such panel, with a gap between said sealing faces which lies between 0.01 and 0.5 mm, for example between 0.1 and 0.3 mm. Despite said gap, good water repellent properties are present and this because said lacquer and hydrophobic components are present.

In a specific embodiment the coupling parts on the first pair of opposite edges are configured as overlapping, so that during coupling on the first pair of opposite edges, coupling with pretension is obtained.

Preferably the first edge, and preferably also the second edge, comprises a lowered edge which extends from the top layer into the substrate, for example in the form of a chamfer or bevel, wherein said lacquer and said hydrophobic components are at least present at the height of said lowered edge and wherein the lacquer forms a decoration separate from the top layer. Preferably the lacquer is present upon the entire contour of said lowered edge. More preferably said hydrophobic components are present upon the entire surface of the lacquer. Most preferably, said first edge comprises said above-mentioned sealing face and said second edge comprises said above-mentioned sealing face, wherein said hydrophobic components also extend upon said sealing faces.

According to a deviating variant, the panels of the set of panels are not rectangular, but have another polygon shape, such as a hexagon shape or an octagon shape, wherein edges of said panels comprise a lacquer and hydrophobic components as described in the second aspect of the invention. Therefore the second aspect of the invention applies mutatis mutandis for all sets of polygon shaped panels.

The invention, according to a third aspect, also relates to a lacquer for treating edges of panels, wherein the lacquer comprises pigments and/or colourants, wherein the lacquer optionally comprises a wetting agent and said wetting agent preferably constitutes between 0.1 and 5 percent by weight of said lacquer. For example said lacquer can comprise between 0.5 and 4 weight percentage of wetting agent, said wetting agent preferably being 3,5-dimethyl-1-hexyn-3-ol. Said wetting agent can also be a long-chain alcohol. Preferably said lacquer comprises at least 1 weight percentage of said wetting agent, at least 2 weight percentage, for example between 2,8 and 3,2 weight percentage or between 2,9 and 3 weight percentage. This lacquer can be used for the method according to the first aspect and for the first alternative of the first aspect, and this lacquer could be the lacquer described in the second aspect. All the embodiments of the lacquer described in said (alternative) first and the second aspect, apply mutatis mutandis for the third aspect and vice versa. In an embodiment, this lacquer is used for the method according to the first aspect with the difference that applying the mixture is optional.

This lacquer preferably comprises silica, for example fumed silica. Fumed silica is very hydrophobic and said lacquer preferably comprises between 0.5 and 5 wt % of fumed silica, preferably between 2 and 5 wt %. The fumed silica can be treated with polydimethylsiloxane and/or dimethyl dichlorosilane and/or can be an amorphous fumed silica.

In an embodiment the lacquer comprises hydrophobic components, wherein said hydrophobic components are preferably chosen from the list of:
hydrophobic polymers such as hydrophobic polycarbodiimides, hydrophobic polyurethanes or hydrophobic acrylate polymers or hydrophobic polysilazanes, wherein the hydrophobic polymers preferably comprise an aliphatic hydrocarbon group, for example with 6 to 34 carbon atoms;
silanes;
(poly)siloxanes;
polysilazanes;
cyclic siloxanes;
(modified) alkyd resins;
(modified) acryl resins;
benzoate esters;
metallic soaps;
silica.

Preferably said hydrophobic components are chosen from the list of hydrophobic components chosen from the list of the possible hydrophobic components of the mixture described in the first, second and/or fourth aspect of the invention.

Preferably the lacquer is a UV curable lacquer and/or a heat curable lacquer. The lacquer can comprise photo-initiators. This is beneficial when the lacquer is a UV curable lacquer. The lacquer can comprise thermo-initiators. The latter is beneficial when the lacquer is heat curable.

The invention, according to a fourth aspect, relates to a mixture for treating edges of a panels, wherein the mixture comprises hydrophobic components and wherein the mixture optionally comprises between 0.1 and 5 percent by weight of a wetting agent. For example said mixture can comprise between 0.5 and 4 weight percentage of wetting agent, said wetting agent preferably being 3,5-dimethyl-1-hexyn-3-ol. Said wetting agent can also be a long-chain alcohol. Preferably said mixture comprises at least 1 weight percentage of said wetting agent, for example 1,5 weight percentage, or at least 2 weight percentage, for example between 2,8 and 3,2 weight percentage or between 2,9 and 3 weight percentage. This mixture can be used for the method according to the first aspect or according to the second alternative of the first aspect, and this mixture could be used to make a set of panels of the second aspect. All the embodiments relating to the mixture described in said (alternative) first and the second aspect, apply mutatis mutandis for the fourth aspect. All the embodiments of the mixture of the fourth aspect, also apply mutatis mutandis for the mixture of the (alternative) first and the second aspect.

Further the said mixture according to the fourth aspect could comprise one or more of the following features:
the hydrophobic components are hydrophobic polymers, being for example a hydrophobic polycarbodiimide, a hydrophobic polyurethane or a hydrophobic acrylate polymer, wherein the hydrophobic polymer comprises an aliphatic hydrocarbon group preferably with 6 to 34 carbon atoms; with the aliphatic hydrocarbon group preferably being selected from the group containing: linear hydrocarbon chains, branched hydrocarbon chains and alicyclic hydrocarbon chains; and wherein preferably the hydrophobic polymer forms part of the mixture between 3 and 40 wt %, preferably between 5 and 30 wt %, and preferably at most 33 wt %.
the hydrophobic components are preferably A-B-A block polymers, wherein A is preferably an acrylate, e.g. a hydrophobic acrylate comprising for example a said aliphatic hydrocarbon group with 6 to 34 carbon atoms, and wherein B is a urethane, said urethane comprising or not comprising a carbodiimide group. Said urethane can be an octadecylurethane;
the mixture is free from fluorocarbons;
the mixture comprises, besides a said hydrophobic polymer, silicon-containing compounds, wherein these silicon-containing compounds are preferably selected from the group: siloxanes, silicones, silicon dioxide (SiO₂, silica) and SiO₂-containing compounds and wherein also preferably these silicon-containing compounds account for 1 to 10 wt %, preferably 5 to 10 wt % of the mixture. These silicon-containing compounds are or are not hydrophobic. For example said silicon-containing compounds can also comprise a said aliphatic hydrocarbon group with between 6 and 34 carbon atoms. Preferably said silicon-containing compounds comprise fumed silica. Fumed silica is very hydrophobic and said mixture preferably comprises between 0.5 and 5 wt % of fumed silica, preferably between 2 and 5 wt %. The fumed silica can be treated with polydimethylsiloxane and/or dimethyl dichlorosilane;
the mixture comprises additives. The additives can be chosen from the list of: antifreeze agents, coagulating agents, cosolvents, emulsifiers or stabilizers, drying agents, catalysts, metallic soaps and biocides against one or more microorganisms;
the mixture can comprise a titanate, for example tetra-n-butyl-titanate;
the mixture comprises a paraffin, for example a paraffin wax;
the mixture comprises a wax emulsion, for example a paraffin wax emulsion or a carnauba wax emulsion;
the hydrophobic components comprise one or more from the list of: a cationic acrylate copolymer dispersion, an anionic alkyd polyurethane emulsion and/or an anionic acrylic polyurethane emulsion;
the mixture comprises solvents or the mixture comprises water, wherein the solvents or water preferably account for between 5 and 80 wt % of the mixture;
the mixture is a solvent-based mixture with a flash point of at least 35° C., preferably at least 55° C., more preferably at least 80° C., most preferably at least 100° C.;
the mixture is a solvent-based mixture comprising alkanes, for example iso-alkanes or aliphatic hydrocarbons;
the mixture is a solvent-based mixture with one or more of the following components: ethylhexyl acetate, propyl acetate or butyl acetate—for example 3-Methoxy-3-Methyl-1-ButylAcetate (MMB-AC) or 1-Methoxy-PropylAcetate (MPA), triethyl citrate, propylene glycol methyl ether, propylene glycol methyl ether acetate, dibasic ester, phthalate ester, glycol diether, benzoate ester, or tetramethoxy ether;
the mixture is water-based or oil-based, and comprises a benzoate ester;
the mixture comprises at least one alkyd polymer and/or a resin, wherein the aforementioned alkyd polymer is preferably urethane or isocyanate modified and wherein also preferably said alkyd polymer accounts for between 3 and 20 wt % of the mixture. Said mixture preferably comprises at most 25 wt % of alkyd resin;
the mixture comprise a perfume. A said perfume can ensure that, the people working in the production environment where the mixture is applied to the panels, do not perceive any unpleasant odor. Preferably said perfume comprises fatty acids, wherein said fatty acids contribute to the water repellency of the mixture;
the mixture comprises titanate, for example tetra n-butyl-titanate, wherein said mixture preferably comprises between 2 and 3 weight percentage of titanate;
the mixture comprises crosslinkers. These crosslinkers can be aziridine crosslinkers or isocyanate crosslinkers. These crosslinkers can be present in an amount of between 0.5 and 2 percentage by weight. These crosslinkers enhance the resistance against soap and can also enhance the water resistance;
the mixture comprises a styrene-butadiene copolymer.

This mixture could be used in a deviating method for manufacturing panels according to the invention,
wherein the panels are rectangular, either square or oblong, and comprise a substrate and a top layer,
wherein the panels are provided with at least a first pair of opposite edges with coupling parts, which allow two such panels to be coupled to each other, wherein in a coupled position a locking is created in a direction perpendicular to the plane of the coupled panels and/or in a direction in the plane of the panels and perpendicular to the coupled side edges, wherein the first pair of opposite edges comprise a first edge and a second edge, and wherein the method comprises the step of forming the coupling parts, and subsequently the steps of:
optionally applying a lacquer on at least a part of the first edge, and preferably also on at least a part of the second edge;
   applying the mixture on at least a part of the first edge, and preferably also on at least a part of the second edge, the mixture being different from the lacquer;
such that at least a portion of the first edge, and preferably also a portion of the second edge, comprises optionally the lacquer and comprises the hydrophobic components,
wherein the lacquer and/or the mixture comprises a wetting agent, wherein preferably said lacquer and/or mixture comprises between 0.1 and 5 percent by weight of said wetting agent.

This deviating method relates to the first aspect of the invention, with the exception that the step of applying the lacquer is optional. Therefore all the embodiments of the first aspect also apply mutatis mutandis for the deviating method. With this deviating method a set of panels according to the second aspect is obtained, with the exception that the presence of said lacquer is optional. Therefore all the embodiments of the second aspect also apply mutatis mutandis for the set of panels obtained by said deviating method and the invention also relates to such a set of panels.

This mixture could be used in a second deviating method for manufacturing panels according to the invention,
wherein the panels are rectangular, either square or oblong, and comprise a substrate and a top layer,
wherein the panels are provided with at least a first pair of opposite edges with coupling parts, which allow two such panels to be coupled to each other, wherein in a coupled position a locking is created in a direction perpendicular to the plane of the coupled panels and/or in a direction in the plane of the panels and perpendicular to the coupled side edges, wherein the first pair of opposite edges comprise a first edge and a second edge, and wherein the method comprises the step of forming the coupling parts, and subsequently the steps of:
optionally applying a lacquer on at least a part of the first edge, and preferably also on at least a part of the second edge;
   applying the mixture on at least a part of the first edge, and preferably also on at least a part of the second edge, the mixture being different from the lacquer-if the lacquer is present-;
such that at least a portion of the first edge, and preferably also a portion of the second edge, comprises optionally the lacquer and comprises the hydrophobic components,
wherein the lacquer and/or the mixture optionally comprises a wetting agent, wherein preferably said lacquer and/or mixture comprises between 0.1 and 5 percent by weight of said wetting agent.

This second deviating method relates to the first aspect of the invention, with the exception that the step of applying the lacquer is optional and the wetting agent is optional. Therefore all the embodiments of the first aspect also apply mutatis mutandis for the deviating method. With this second deviating method a set of panels according to the second aspect is obtained, with the exception that the presence of said lacquer and said wetting agent is optional. Therefore all the embodiments of the second aspect also apply mutatis mutandis for the set of panels obtained by said second deviating method and the invention also relates to such a set of panels.

For better illustration of the features of the invention, some preferred embodiments are described hereunder, as examples without any limiting character, referring to the appended drawings, in which:

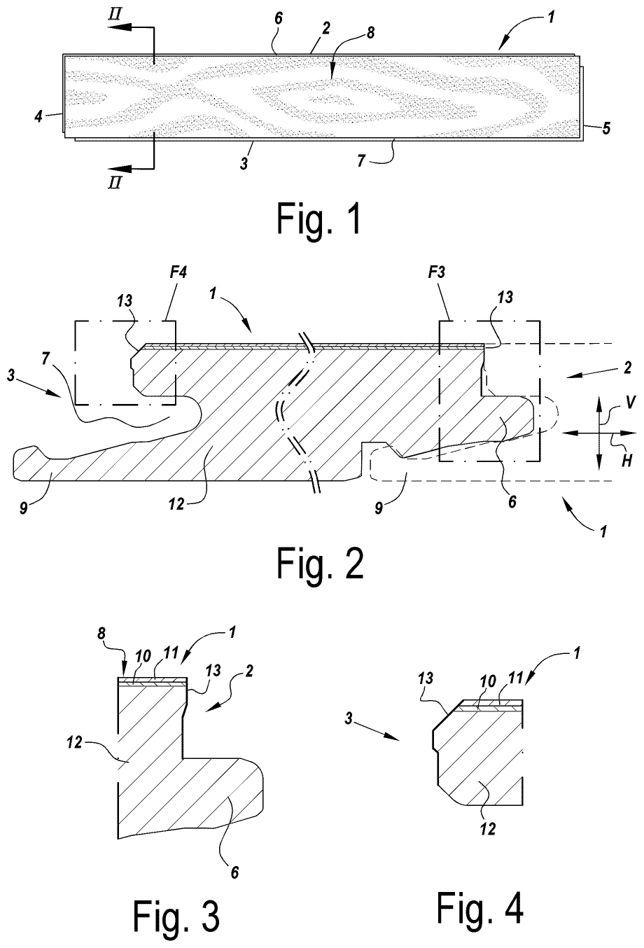

FIG. 1 shows a floor panel obtained by a method of the invention;

FIG. 2 shows this floor panel in a cross-section along line II-II in FIG. 1;

FIG. 3 illustrates detail F3 of FIG. 2;

FIG. 4 illustrates detail F4 of FIG. 2;

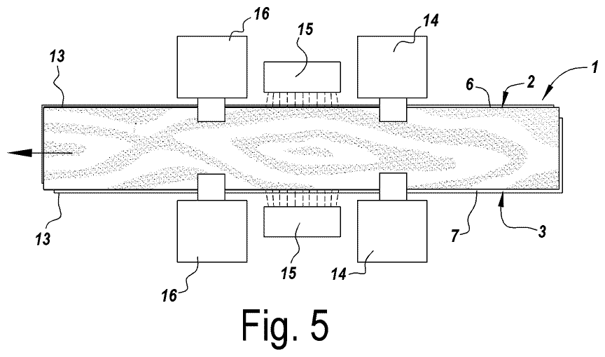

FIG. 5 schematically shows a method according to invention.

FIG. 1 shows an elongated rectangular floor panel 1 that is provided with coupling parts on two pairs of opposite edges 2-3 (the long edges) and 4-5 (the short edges). The coupling parts allow the panel 1 to be coupled on its first long edge 2 to the second long edge 3 of another such panel 1; and allow the panel 1 to be coupled on its first short edge 4 to the second short edge 5 of another such panel 1.

The panel 1 comprises, from top to bottom: a top layer 8, a substrate 12, an optionally a balancing layer. This top layer 8 comprises a decorative layer 10, being preferably a resin impregnated printed paper, and wear layer 11, being preferably a resin impregnated translucent paper with optionally hard particles such as aluminium oxide. The balancing layer is preferably a resin impregnated kraft paper. The substrate 12 is preferably MDF or HDF, with for example a swelling rate of 2%, 4%, 6%, 8%, 10%, 12% or 15% measured according to EN 317:1993.

FIG. 2 shows the floor panel 1 from FIG. 1 in a cross-section along line II-II in FIG. 1, and illustrates that the coupling parts form a first locking system on the long edges 2-3, which provides locking in the plane of the panels 1 and perpendicular to the long edges 2-3, namely locking in the horizontal direction H; and a second locking system that produces locking perpendicular to the plane of the panels 1, namely locking in the vertical direction V. The coupling parts illustrated in this example are mainly formed by a tongue 6 and a groove 7. The groove 7 is delimited by an upper lip and a lower lip 9, wherein the lower lip 9 projects farther in the distal direction than the upper lip.

The coupling parts are of the type that allows two such panels 1 to be coupled together selectively by means of a turning motion and/or by means of a horizontal sliding movement of one such panel 1 relative to another such panel 1. In the example, the coupling parts are produced entirely in the substrate 12.

Preferably the coupling parts on the first pair of opposite edges 2-3 are configured as overlapping, so that during coupling on the first pair of opposite edges 2-3, coupling with pretension is obtained. As a result, in the coupled state, the long edges 2-3 of the coupled panels 1 are pushed together. This can be obtained because in the coupled state the lower lip 9 is slightly bent elastically. This elastic bending gives rise to a compressive force that presses the coupled edges 2-3 against each other.

The panel 1 shown in FIG. 1 has been obtained by the method shown in FIG. 5 and comprising the successive steps of:
forming the coupling parts, with the panel 1 shown in FIG. 5 already comprising said coupling parts;
applying a lacquer on a portion of each of the long edges 2-3, and this with the aid of an application device 14;
partially drying and curing the lacquer, and this with the aid of IR lamps 15 (or alternatively with the aid of UV lamps when the lacquer is UV curable);
applying a mixture comprising hydrophobic components on said portions of the long edges 2-3, the mixture being different from the lacquer, and this with the aid of an application device 16;
such that said portions of the long edges 2-3 comprises both the lacquer and the hydrophobic components, this being indicated with the number 13.

During these successive steps the panel 1 is preferably moved by a chain transporting device according to the direction as indicated by the arrow in FIG. 5.

Applying said lacquer with the application device 14 can be done in one single step, for example with one needle, with one spray gun, with one transfer wheel, with one vacumate, etc. However this can also be done in two, three or more partial steps. Applying said mixture comprising hydrophobic components can be done in one single step, for example with one needle, with one spray gun, with one transfer wheel, with one vacumate, etc. However this can also be done in two, three or more partial steps.

Here below is a non-exhaustive list of possibilities to apply a said lacquer and a said mixture:
first partial step of applying said mixture, subsequent (partial) drying, second partial step of applying said mixture, subsequent (partial) drying, followed by the application of said lacquer, subsequent (partial) drying;
first partial step of applying said mixture, subsequent second partial step of applying said mixture, (partial) drying, followed by the application of said lacquer, subsequent (partial) drying;
first partial step of applying said mixture, second partial step of applying said mixture, followed by the application of said lacquer, subsequent (partial) drying;
first partial step of applying said mixture, subsequent (partial) drying, followed by the application of said lacquer, subsequent (partial) drying, second partial step of applying said mixture;
first partial step of applying said mixture, subsequent (partial) drying, followed by the application of said lacquer, subsequent (partial) drying, second partial step of applying said mixture, subsequent (partial) drying;
first partial step of applying said mixture, subsequent (partial) drying, followed by the application of said lacquer, second partial step of applying said mixture, subsequent (partial) drying;
first partial step of applying said mixture, followed by the application of said lacquer, subsequent (partial) drying, second partial step of applying said mixture;
first partial step of applying said mixture, followed by the application of said lacquer, second partial step of applying said mixture, subsequent (partial) drying;
the step of applying said lacquer, first partial step of applying said mixture, subsequent (partial) drying, second partial step of applying said mixture, subsequent (partial) drying;
the step of applying said lacquer, first partial step of applying said mixture, second partial step of applying said mixture, subsequent (partial) drying.
the step of applying said lacquer, subsequent (partial) drying, first partial step of applying said mixture, subsequent (partial) drying, second partial step of applying said mixture, subsequent (partial) drying;
the step of applying said lacquer, subsequent (partial) drying, first partial step of applying said mixture, second partial step of applying said mixture, subsequent (partial) drying;
the step of applying said lacquer, subsequent (partial) drying, first partial step of applying said mixture, second partial step of applying said mixture.

Said portion comprising the lacquer and the hydrophobic components is indicated by a bold line with the number 13 in FIGS. 3 and 4. The lacquer forms a thin film upon said portion, part of the mixture will have penetrated the substrate 12 at the height of said portion and hydrophobic components will be present at the surface of the lacquer, and preferably, if said substrate is MDF or HDF or particle board, hydrophobic components will also be present between the wood fibers or wood particles of the substrate which is present below said lacquer.

Both said long edges 2-3 do or do not comprise a lowered edge. For simplicity, the possibility of the lowered edge is indicated on the left long edge 3 of FIG. 2, and on the right long edge 2 of FIG. 2, the possibility where no lowered edge is present is indicated. Both said long edges 2-3 having a sealing face which are provided to contact each other. If a said lowered edge is present, both the lowered edge and said sealing face can comprise said lacquer and hydrophobic components. Another possibility is that said lowered edge comprises both the lacquer and the hydrophobic components and that said sealing face only comprises said hydrophobic components.

Preferably the pair of opposite short edges 4-5 is provided with coupling parts that comprise locking elements so that in the coupled state, locking occurs in the direction V perpendicular to the surface of the coupled panels 1 and locking also occurs in the direction H in the plane of the coupled panels 1 and perpendicular to the coupled edges 4-5. The coupling parts can be configured as the coupling parts of the long edges 2-3, but can also be configured differently.

The present invention is by no means limited to the embodiments described above.

### Testing of Examples

Laminate floor panels comprising an HDF substrate and coupling parts in the form of tongue and grooves, were treated with mixtures according to the invention. In order to determine the water-resistant properties of said laminate floor panels the swelling at the edges was determined.

Edges of said laminate panels were treated with a mixture according to the invention. To test the water-resistant properties, a test set-up according to the Nalfa surface swell test was used. For the Nalfa surface swell test, a cylinder with water is placed on the T-joint of a floor covering comprising said laminate floor panels and this for 24 h. Then the floor covering is dried for another 24 h. Afterwards the swelling of the material is measured by a measurement device. Instead of using pure water, water comprising 2 wt % of soap was used, this because cleaning of floor coverings often makes use of soap, such that this test can be indicated as an adapted Nalfa test.

After this adapted Nalfa test, a visual assessment was made.

To measure the thickness use was made of a thickness gauge (Käfer FD50). Measurements were taken at different places along the length of the edges.

Three mixtures were applied to the edges of the floor panels and tested according to said adapted Nalfa test:

Mixture 1:30 wt % of hydrophobic polyurethane, 37 wt % of solvent comprising hydrocarbons with 11 to 14 carbons, 5 wt % of co-solvent 2-ethylhexylacetate, 25 wt % of a long-oil alkyd resin, 3 wt % of 2-ethylhexyl titanate.

Mixture 2:50 wt % of hydrophobic polyurethane, 24 wt % of solvent comprising hydrocarbons with 15 to 20 carbons, 13 wt % of white mineral oil, 5 wt % of co-solvent 2-ethylhexylacetate, 3 wt % of 2-ethylhexyl titanate, 0.5 wt % of octadecyltriethoxysilane.

Mixture 3:50 wt % of hydrophobic polyurethane, 21 wt % of solvent comprising hydrocarbons with 11 to 14 carbons, 21 wt % of co-solvent 2-ethylhexylacetate, 1.5 wt % hydrophobic fumed amorphous silica.

| | Average swelling | Maximum swelling |
|---|---|---|
| | (mm) | (mm) |
| Reference no mixture | 0.511 | 0.800 |
| Mixture 1 | 0.083 | 0.145 |
| Mixture 2 | 0.063 | 0.130 |
| Mixture 3 | 0.059 | 0.090 |

As can be viewed in the table above, with the aid of mixtures according to the invention, edge swelling was significantly reduced. The water-resistant properties of the floor panels are thus significantly increased when a mixture according to the invention is used. Further when no mixture is used (reference), the swelling of the edges is visible, while, when a mixture according to the invention is used, no swelling is visible.

1.-34. (canceled)

35. A method for manufacturing panels, wherein the panels are rectangular, either square or oblong, and comprise a substrate and a top layer,
wherein the panels are provided with at least a first pair of opposite edges with coupling parts, which allow two such panels to be coupled to each other, wherein in a coupled position a locking is created in a direction perpendicular to the plane of the coupled panels and/or in a direction in the plane of the panels and perpendicular to the coupled side edges;
wherein the first pair of opposite edges comprise a first edge and a second edge, and wherein the method comprises the step of forming the coupling parts, and subsequently at least the following two steps:
applying a lacquer on at least a part of the first edge;
applying a mixture comprising hydrophobic components on at least a part of the first edge, the mixture being different from the lacquer,
such that at least a portion of the first edge comprises both the lacquer and the hydrophobic components;
wherein the lacquer and/or the mixture comprises a wetting agent.

36. The method according to claim 35, wherein said lacquer and/or mixture comprises between 0.1 and 5 percent by weight of said wetting agent.

37. The method according to claim 36, wherein the wetting agent is an alcohol.

38. The method according to claim 36, wherein the wetting agent is a long-chain alcohol or 3,5-dimethyl-1-hexyn-3-ol.

39. The method according to claim 36, wherein the lacquer comprises a said wetting agent and also the mixture comprises a said wetting agent;
wherein the wetting agent of the lacquer and the wetting agent of the mixture can or cannot be the same.

40. The method according to claim 36, wherein the lacquer comprises a said wetting agent;
wherein the lacquer comprises between 2 and 4 weight percentage of said wetting agent.

41. The method according to claim 36, wherein the first edge comprises a lowered edge which extends from the top layer into the substrate, in the form of a chamfer or bevel;
wherein the lacquer and the mixture are at least applied upon said lowered edge; and
wherein the lacquer forms a decoration separate from the top layer.

42. The method according to claim 36, wherein the lacquer is water based.

43. The method according to claim 36, wherein the mixture is solvent based.

44. The method according to claim 36, wherein the mixture is water based.

45. The method according to claim 36, wherein applying the lacquer takes place before applying the mixture;
wherein the mixture penetrates at least partially through the lacquer into the substrate of the said edge and at least a part of the hydrophobic components extend on the upper surface of the lacquer.

46. The method according to claim 36, wherein the lacquer comprises pigments and/or colorants.

47. The method according to claim 36, wherein the hydrophobic components comprise one or more of the following:
hydrophobic polymers chosen from the list of: hydrophobic polycarbodiimides, hydrophobic polyurethanes or hydrophobic acrylate polymers or hydrophobic polysilazanes;
silanes;
(poly)siloxanes;
polysilazanes;
cyclic siloxanes;
(modified) alkyd resins;
(modified) acryl resins;
benzoate esters;
metallic soaps;
silica.

48. A set of panels for a covering, wherein the panels are rectangular, either square or oblong,
wherein the panels comprise a substrate and a top layer;
wherein the panels comprise at least a first pair of opposite edges with coupling parts, which allow two such panels to be coupled to each other;
wherein in a coupled position a locking is created in a direction perpendicular to the plane of the coupled panels and/or in a direction in the plane of the panels and perpendicular to the coupled side edges;
wherein the first pair of opposite edges comprise a first edge and a second edge; and
wherein said first edge, is at least partially covered with a lacquer;
wherein hydrophobic components extend on the upper surface of said lacquer.

49. The set of panels according to claim 48, wherein the lacquer comprises pigments and/or colourants.

50. The set of panels according to claim 48, wherein the first edge comprises a sealing face, and the second edge comprises a sealing face;
wherein in a coupled position, the sealing face of the first edge of the panel is close to the sealing face of the second edge of the other such panel, with a gap between said sealing faces which lies between 0.01 and 0.5 mm.

51. The set of panels according to claim 48, wherein the first edge comprises a lowered edge which extends from the top layer into the substrate, in the form of a chamfer or bevel;
wherein said lacquer and said hydrophobic components are at least present at the height of said lowered edge and wherein the lacquer forms a decoration separate from the top layer.

52. The set of panels according to claim 48, wherein the hydrophobic components comprise one or more of the following:
hydrophobic polymers;
silanes;
(poly)siloxanes;
polysilazanes;
cyclic siloxanes;
(modified) alkyd resins;
(modified) acryl resins;
benzoate esters;
metallic soaps;
silica.

53. A lacquer for treating edges of panels, wherein the lacquer comprises pigments and/or colourants and wherein the lacquer comprises between 0.5 and 5 percent by weight of a wetting agent.

54. The lacquer according to claim 53, wherein the lacquer comprises hydrophobic components;
wherein said hydrophobic components are chosen from the list of:
hydrophobic polymers;
silanes;
(poly)siloxanes;
polysilazanes;
cyclic siloxanes;
(modified) alkyd resins;
(modified) acryl resins;
benzoate esters;
metallic soaps;
silica.
